(19) United States
(12) Patent Application Publication
(10) Pub. No.: US 2018/0210132 A1
(43) Pub. Date: Jul. 26, 2018

(54) LIGHT GUIDING PLATE, METHOD OF MANUFACTURING THEREOF AND BACKLIGHT MODULE WITH LIGHT GUIDING PLATE

(71) Applicants: CHUNGHWA PICTURE TUBES, LTD., Taoyuan City (TW); TATUNG UNIVERSITY, Taipei City (TW)

(72) Inventors: Chuang-Hung CHIU, Hsinchu County (TW); Chao-Heng CHIEN, Taipei City (TW); Yueh-Hao CHEN, New Taipei City (TW); Wei-Cheng CHIEN, Taipei City (TW)

(21) Appl. No.: 15/485,214

(22) Filed: Apr. 11, 2017

(30) Foreign Application Priority Data
Jan. 20, 2017 (CN) 201710041341.7

(51) Int. Cl. F21V 8/00

(52) U.S. Cl. CPC G02B 6/0038; G02B 6/0051; G02B 6/002; G02B 6/0065; G02B 6/0031

(57) ABSTRACT

A light guiding plate includes a light emitting surface, a structural surface, a light incident surface and a plurality of trench structures. The structural surface is opposite to the light emitting surface. The light incident surface connects between the light emitting surface and the structural surface. The trench structures are formed at intervals on the structural surface. Each of the trench structures includes a first surface and a second surface. The first surface connects with the structural surface. A first angle included between the first surface and the structural surface ranges from 110 degrees to 130 degrees. The second surface connects with the structural surface. The second surface connects with the first surface to form a trench axis. The first surface of each of the trench structures is closer to the light incident surface relative to the corresponding second surface.

### RELATED APPLICATIONS

This application claims priority to Chinese Application Serial Number 201710041341.7, filed Jan. 20, 2017, which is herein incorporated by reference.

### BACKGROUND

### Technical Field

The present disclosure relates to light guiding plates of high transparency. More particularly, the present disclosure relates to flexible transparent light guiding plates.

### Description of Related Art

The commonly seen transparent displays have various usages and appearances. For example, some transparent displays allow the user to see the images at the back of the transparent displays when the transparent displays are in the sleeping mode. The transparent displays in the market can be roughly classified into two types. One type is transparent displays adopting organic light emitting diodes (OLED). However, the organic light emitting diodes are of a high cost, difficult workmanship and a shorter working life. Another type is transparent displays adopting thin film transistor panels. The backlight model can only display when the thin film transistor panel is irradiated by an additional light source. In order to make the light source away from the backlight module to be more even, optical elements such as diffusion film, lens or grating are readily disposed. However, the overall transparent rate would be reduced accordingly, such that the output/input ratio of the backlight module is also reduced. Moreover, the transparent effect of the transparent display will be affected. Therefore, the existing transparent displays still have inconvenience and defect, which should be improved. In order to solve the problem above, people in the related fields try their best to look for a solution. As a result, how to effectively solve the problem above is undoubtedly one of the important issues to be researched. In addition, it is also a target needed to be improved by the related fields at present.

### SUMMARY

A technical aspect of the present disclosure is to provide a light guiding plate of high transparency, method of manufacturing thereof and a backlight module with the light guiding plate.

According to an embodiment of the present disclosure, a light guiding plate includes a light emitting surface, a structural surface, a light incident surface and a plurality of trench structures. The structural surface is opposite to the light emitting surface. The light incident surface connects between the light emitting surface and the structural surface. The trench structures are formed at intervals on the structural surface. Each of the trench structures includes a first surface and a second surface. The first surface connects with the structural surface. A first angle included between the first surface and the structural surface ranges from 110 degrees to 130 degrees. The second surface connects with the structural surface. The second surface connects with the first surface to form a trench axis. The first surface of each of the trench structures is closer to the light incident surface relative to the corresponding second surface.

In one or more embodiments of the present disclosure, a reflective index of the light guiding plate ranges from 1.4 to 1.6.

In one or more embodiments of the present disclosure, a distance between the trench axis of each of the trench structures and the adjacent trench axis ranges from 300 μm to 500 μm.

In one or more embodiments of the present disclosure, a distance between each of the trench axes and the adjacent trench axis is the same.

In one or more embodiments of the present disclosure, the trench axes of the trench structures are parallel with each other.

In one or more embodiments of the present disclosure, a distance between a first connection point where the first surface of each of the trench structures and the structural surface connect and a second connection point where the second surface and the structural surface connect ranges from 150 μm to 250 μm.

In one or more embodiments of the present disclosure, a perpendicular distance from the trench axis of each of the trench structures to a virtual extension surface of the structural surface ranges from 50 μm to 150 μm.

In one or more embodiments of the present disclosure, the perpendicular distance from each of the trench axes to the virtual extension surface is the same.

In one or more embodiments of the present disclosure, the respective perpendicular distances from at least two trench axes to the virtual extension surface are different from each other.

In one or more embodiments of the present disclosure, the first angle included between the first surface of each of the trench structures and the structural surface is the same.

In one or more embodiments of the present disclosure, the respective first angles included between the first surface of at least two trench structures and the structural surface are different from each other, in which the first angle of either one of the two trench structures relatively closer to the light incident surface is smaller than or equal to the first angle of either one of the trench structures relatively farther away from the light incident surface.

In one or more embodiments of the present disclosure, the light guiding plate further includes a scattering layer. The scattering layer is disposed on the light emitting surface.

In one or more embodiments of the present disclosure, the scattering layer includes a transparent main body and a plurality of micro-particles. The micro-particles are distributed in the transparent main body.

In one or more embodiments of the present disclosure, a second angle included between the light incident surface and the light emitting surface ranges from 40 degrees to 70 degrees.

In one or more embodiments of the present disclosure, the light incident surface includes a first subsidiary light incident surface and a second subsidiary light incident surface. The first subsidiary light incident surface is connected to the light emitting surface. The second subsidiary light incident surface is connected between the first subsidiary light incident surface and the structural surface. A second angle included between the first subsidiary light incident surface and the light emitting surface is larger than a third angle included between an extension surface of the second subsidiary light incident surface and an extension surface of the light emitting surface.

In one or more embodiments of the present disclosure, the third angle included between the second subsidiary light incident surface and the light emitting surface ranges from 20 degrees to 40 degrees.

According to an embodiment of the present disclosure, a backlight module includes the light guiding plate mentioned above, an optical auxiliary tool and a light source. The optical auxiliary tool covers at least part of the light incident surface of the light guiding plate and an end of the light emitting surface near to the light incident surface. The light source is disposed in the optical auxiliary tool and configured for emitting a light ray. The optical auxiliary tool is configured for reflecting the light ray to the light guiding plate.

According to an embodiment of the present disclosure, a method of manufacturing a light guiding plate is provided. The manufacturing method includes providing a transparent workpiece, the transparent workpiece including a light emitting surface, a structural surface opposite to the light emitting surface, and a light incident surface connected between the light emitting surface and the structural surface; and forming a plurality of trench structures at intervals on the structural surface, in which each of the trench structures includes a first surface and a second surface, the first surface connects with the structural surface, and a first angle included between the first surface and the structural surface ranges from 110 degrees to 130 degrees, the second surface connects with the structural surface, and the second surface connects with the first surface to form a trench axis, in which the first surface of each of the trench structures is closer to the light incident surface relative to the corresponding second surface.

In one or more embodiments of the present disclosure, the light incident surface includes a first subsidiary light incident surface and a second subsidiary light incident surface. The first subsidiary light incident surface is connected to the light emitting surface. The second subsidiary light incident surface is connected between the first subsidiary light incident surface and the structural surface. A second angle included between the first subsidiary light incident surface and the light emitting surface is larger than a third angle included between an extension surface of the second subsidiary light incident surface and an extension surface of the light emitting surface.

In one or more embodiments of the present disclosure, the manufacturing method further includes forming a scattering layer on the transparent workpiece to cover at least part of the light emitting surface.

It is understood from the embodiments of the present disclosure that, the trench structures, each of which has two surfaces, are formed at intervals on the structural surface opposite to the light emitting surface in the light guiding plate, such that the light ray entering the light guiding plate in the present disclosure can leave the light guiding plate from the light emitting surface after refracted at the structural surface through the trench structures. In addition, the light ray is further scattered by a scattering layer disposed on the light emitting surface before leaving the light guiding plate. The light guiding plate in the present disclosure is able to further adjust an angle included between a surface of each of the trench structures near to the light incident surface and the structural surface, in order to achieve various optical effects. Thus, the application of the light guiding plate in the present disclosure further has an adjustable flexibility. Therefore, the present disclosure can solve the limitation by a light guiding plate with a relatively worse transparency in the prior art, such that the brightness required by a backlight module becomes smaller, achieving a better display effect.

### BRIEF DESCRIPTION OF THE DRAWINGS

The disclosure can be more fully understood by reading the following detailed description of the embodiments, with reference made to the accompanying drawings as follows:

FIG. 1 is a sectional side view of a light guiding plate according to an embodiment of the present disclosure;

FIG. 2 is an enlarged schematic view of the light guiding plate of FIG. 1 shown at the part of the hidden frame A;

FIG. 3 is a sectional side view of a backlight module according to an embodiment of the present disclosure;

FIG. 4 is a schematic view of a light path in the backlight module of FIG. 3 after a light ray enters into the backlight module;

FIG. 5 is a flow chart of a manufacturing method of a light guiding plate according to an embodiment of the present disclosure; and

FIGS. 6-9 are schematic sectional views of various stages in a manufacturing method of a light guiding plate according to different embodiments of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

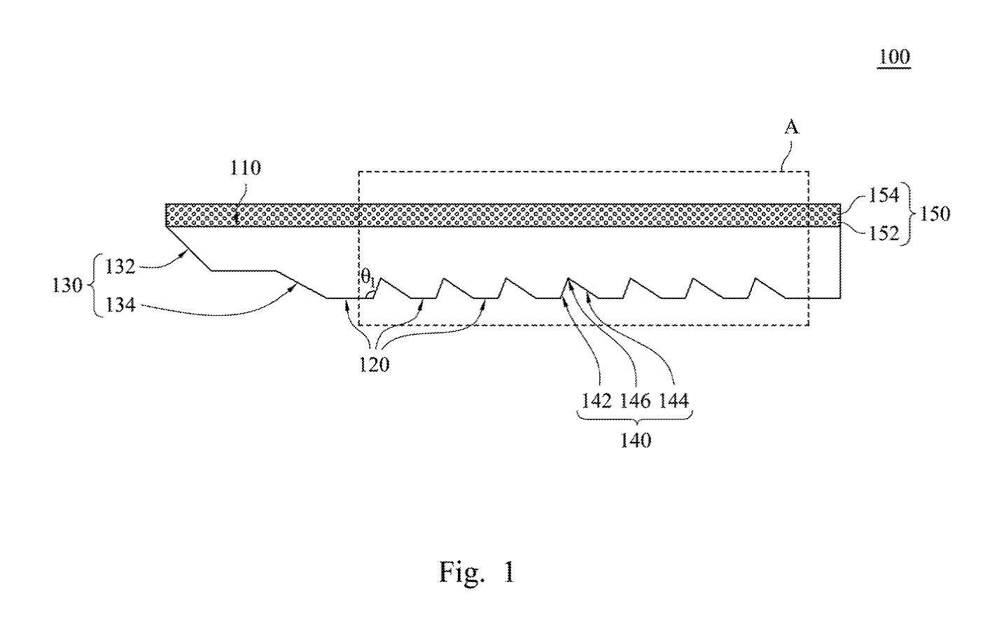

In order to solve the well-known problem of a relatively low optical output/input ratio of a light guiding plate in a backlight module, a light guiding plate 100 is provided in the present disclosure to provide a backlight module of a higher optical output/input ratio. FIG. 1 is a sectional side view of a light guiding plate 100 according to an embodiment of the present disclosure. As shown in FIG. 1, the light guiding plate 100 includes a light emitting surface 110, a structural surface 120, a light incident surface 130 and a plurality of trench structures 140. The structural surface 120 is opposite to the light emitting surface 110. In this embodiment, the structural surface 120 can be mutually parallel with the light emitting surface 110. The light incident surface 130 connects between the light emitting surface 110 and the structural surface 120. The trench structures 140 are formed at intervals on the structural surface 120. Each of the trench structures 140 includes a first surface 142 and a second surface 144. The first surface 142 connects with the structural surface 120. A first angle θ1 included between the first surface 142 and the structural surface 120 ranges from 110 degrees to 130 degrees. The second surface 144 connects with the structural surface 120. The second surface 144 connects with the first surface 142 to form a trench axis 146. In other words, the second surface 144 connects between the structural surface 120 and the first surface 142, and the trench axis 146 is formed at where the first surface 142 and the second surface 144 connect. In some embodiments, the first surface 142 and the second surface 144 are flat surfaces. However, this does not intend to limit the present disclosure. In some other embodiments, the first surface 142 and the second surface 144 are curved surfaces. In some embodiments, the surface in each of the trench structures 140 near to the light incident surface 130 is defined as the first surface 142, while the surface in each of the trench structures 140 away from the light incident surface 130 is defined as the second surface 144.

When a light ray passes through the interface between the first surface 142 and the air and the interface between the air and the second surface 144, the light ray is refracted towards the direction of the light emitting surface 110 because of the change of the refractive index. In this way, when the light ray enters into the trench structures 140, the light ray is preferably guided to the light emitting surface 110 by refraction. Similarly, even if the light ray is totally reflected by the light emitting surface 110 and propagates back to the structural surface 120 and the trench structure 140, the value of the incident angle of the light ray to be guided to the light emitting surface 110 next time will be changed as well (the magnitude of the change is related to the refractive index of the light guiding plate 100). Thus, after a single time or a multiple of times of total reflection and/or refraction of the light ray by the light emitting surface 110 and/or the structural surface 120 and the trench structure 140, the value of the incident angle of the light ray reaching the light emitting surface 110 is gradually reduced with each time of refraction, until the incident angle is smaller than the critical angle of the light guiding plate 110 such that the light ray totally leaves from the light emitting surface 110. Meanwhile, the limitation to the first angle θ1 as aforementioned, i.e., the limitation of the first angle θ1 in the range of 130≥θ1≥110, is able to further allow the light ray to be emitted from the light emitting surface 110 in a more concentrated manner.

In addition, the trench structures 140 are still able to maintain the interface between the first surface 142 and the air and the interface between the air and the second surface 144 when the light-guiding plate 110 is bent. Thus, the trench structures 140 can still have at least part of the refractive effect. As a result, when the light guiding plate 100 of the present disclosure is bent and still falls within the interval of the specific bending radius, for example, within the bending radius of 117 mm to 44 mm, the uniformity of the brightness can still be controlled between about 70% and 90%.

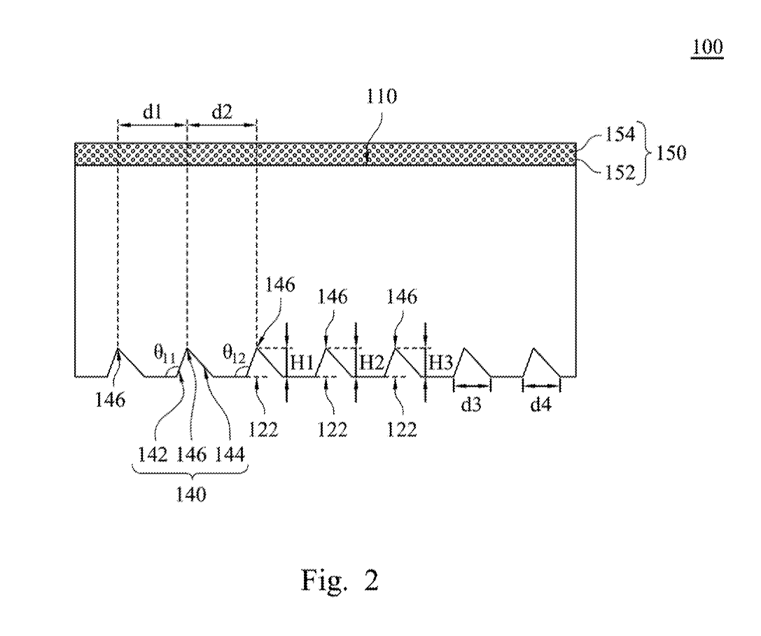

FIG. 2 is an enlarged schematic view of the light guiding plate 100 of FIG. 1 shown at the part of the hidden frame A. As shown in FIG. 2, the trench axis 146 of the trench structure 140 and the trench axis 146 of the adjacent trench structure 140 have distances d1, d2, etc. in between. In this embodiment, the length of the distances d1, d2 ranges from 300 μm to 500 μm. In some embodiments, the trench axes 146 of the trench structures 140 are parallel with each other. In some embodiments, the distances d1, d2 are constant values. In some embodiments, the distances d1, d2 are substantially equal. In this way, the distance between any two adjacent trench axes 146 of the light guiding plate 100 has a consistency, such that the light ray can be refracted to the light emitting surface 110 evenly. Moreover, through the limitation to the distances d1, d2 between any two adjacent trench axes 146 of the light guiding plate 100, when the distances d1, d2 are too small, the condition of mutual interference between the light rays refracted by the trench structures 140 is avoided, or when the distances d1, d2 are too large, a part of the light ray being out of the guidance by the trench structures 140 is avoided. Thus, a balance between the transparency and the astigmatism effect of the light guiding plate 100 is achieved.

In some embodiments, a first connection point where the first surface 142 of each of the trench structures 140 and the structural surface 120 connect and a second connection point where the second surface 144 and the structural surface 120 connect have distances d3, d4, etc. in between. In this embodiment, the length of the distances d3, d4 ranges from 150 μm to 250 μm. In this way, the trench structures 140 are avoided to be visually highlighted in the light guiding plate 100, and the distance of the light ray as refracted when passing through the interface between first surface 142 and the air and the interface between the air and the second surface 144 is further controlled. In some embodiments, the distances d3, d4 are constant values. In some embodiments, the distances d3, d4 are substantially equal.

In some embodiments, the first angle θ1 included between the first surface 142 of each of the trench structures 140 and the structural surface 120 is substantially the same. For example, the first angles θ11, θ12, etc. in FIG. 2 provide a consistent path of refraction to the light ray. In some other embodiments, the respective first angles θ11, θ12 included between the first surface 142 of at least two trench structures 140 and the structural surface 120 can be different from each other. As shown in FIGS. 1-2, the first angle θ11 of either one of the two trench structures 140 relatively closer to the light incident surface 130 is smaller than or equal to the first angle θ12 of either one of the trench structures 140 relatively farther away from the light incident surface 130. The change of the first angles θ11, θ12, for example, can be reducing or strictly reducing. Since the change of the first angles θ11, θ12 is related to the distance of the trench structures 140 from the light incident surface 130, the incident angle of the light ray on the light emitting surface 110 after refracted will change with the distance from the light incident surface 130. Thus, various optical effects can be achieved.

In addition, according to the trigonometric functions, the distances d3, d4 between the first connection point where the first surface 142 of each of the trench structures 140 and the structural surface 120 connect and the second connection point where the second surface 144 and the structural surface 120 connect, and the first angle θ1 included between the first surface 142 and the structural surface 120, determine the depth of the trench structures 140. In other words, the perpendicular distances H1, H2, H3, etc. from the trench axes 146 to a virtual extension surface 122 of the structural surface 120 will vary with the combination of the distances d3, d4 and the first angle θ1. For example, in some embodiments, when the distances d3, d4 are mutually equal and the first angle θ1 is a constant value, the perpendicular distances H1, H2, H3 from the trench axes 146 to the virtual extension surface 122 are substantially equal. For example, in some other embodiments, when the distances d3, d4 are constant, and the first angles θ11, θ12 vary with the distance between the trench structures 140 and the light incident surface 130, the perpendicular distances H1, H2, H3 from the trench axes 146 to the virtual extension surface 122 will be different from each other. In some embodiments, the perpendicular distances H1, H2, H3 lie between 50 μm and 150 μm. Through the limitation to the depth of the trench structures 140, the influence to the mechanical strength and the flexibility of the light guiding plate 100 is avoided. Furthermore, the trench structures 140 are avoided to be visually highlighted in the light guiding plate 100.

It is worth to note that, for the trench structures 140 as mentioned, the distances d1, d2 between the trench axis 146 of the trench structure 140 and the trench axis 146 of the adjacent trench structure 140, the distances d3, d4 between the first connection point where the first surface 142 of each of the trench structures 140 and the structural surface 120 connect and the second connection point where the second surface 144 and the structural surface 120 connect, and the first angle θ1 included between the first surface 142 of each of the trench structures 140 and the structural surface 120, as cited herein are only illustrative and are not to limit the claimed scope. For examples, in some other embodiments, the distances between any two adjacent trench axes 146 of the light guiding plate 100 are different from each other, so as to correspond to the condition of reducing energy with increasing distance with the propagation of the light ray in the light guiding plate 100, such that the light field leaving the light emitting surface 110 can be more even. In some other embodiments, the trench axes 146 of the trench structures 140 can be not parallel with each other, such that the distances d1, d2 between two adjacent trench axes 146 in the light guiding plate 100 can be varied. For example, in some other embodiments, the distances d3, d4 and the perpendicular distances H1, H2, H3, etc. can also be varied. It should be noted that, without departing from the spirit and the claimed scope of the present disclosure, the people having ordinary skill in the art is able to change, replace or modify the trench structures 140 according to the actual conditions, provided that the light ray can be partially refracted to the light emitting surface 110 after passing through the trench structures 140.

Please keep referring to FIG. 2. In some embodiments, the light guiding plate 100 further includes a scattering layer 150. The scattering layer 150 is disposed on the light emitting surface 110. The scattering layer 150 includes a transparent main body 152 and a plurality of micro-particles 154. The micro-particles 154 are distributed in the transparent main body 152. The micro-particles 154 are configured for scattering the light ray. In some embodiments, the thickness of the transparent main body 152 ranges from 100 μm to 300 μm. In some embodiments, the diameter of each of the micro-particles 154 ranges from 0.5 μm to 2 μm. In some embodiments, the percentage density of the micro-particles 154 by weight occupies about 0.1% to 2% of the scattering layer 150. When the light ray passes through the micro-particles 154, the light ray will be scattered by the micro-particles 154 to diverge to various directions, so as to form a more even light field outside the light guiding plate 100.

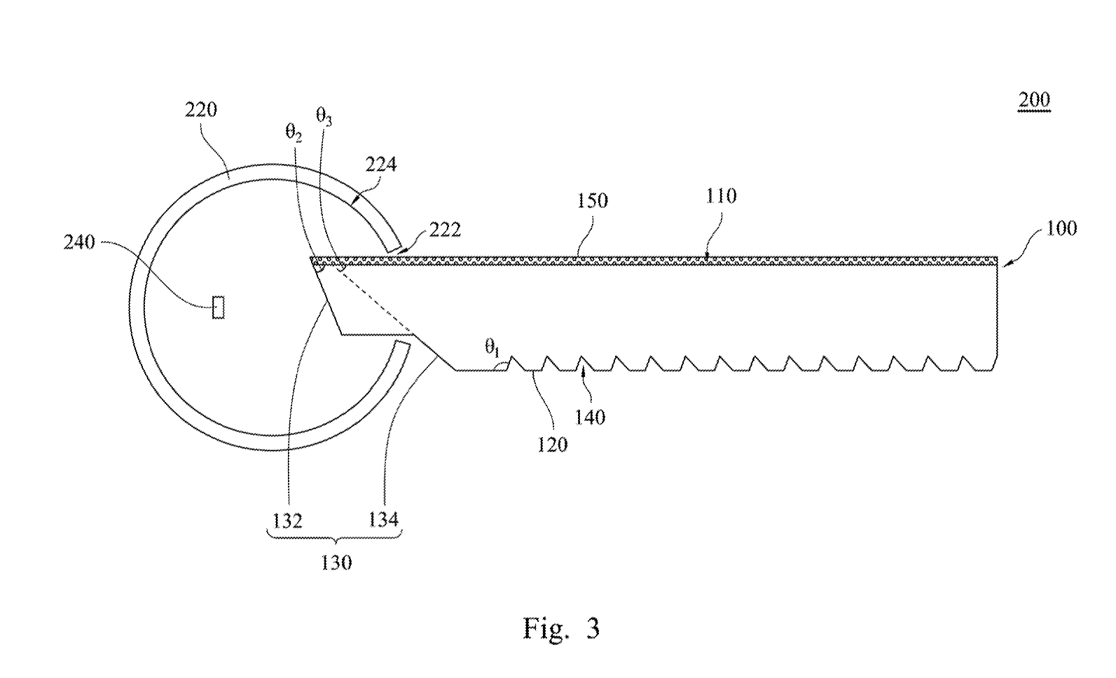

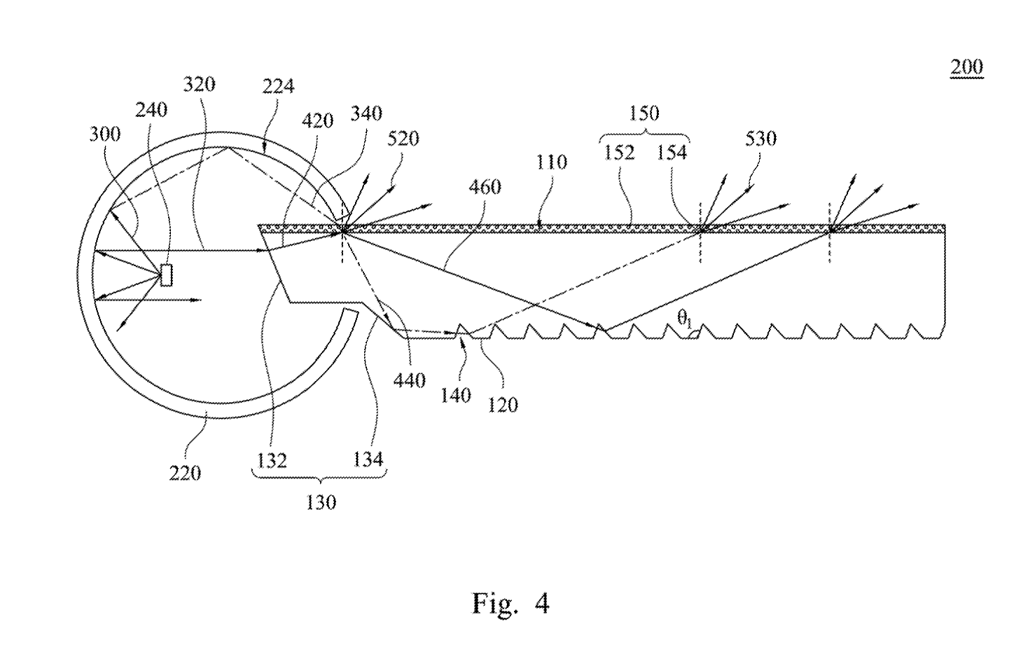

FIG. 3 is a sectional side view of a backlight module 200 according to an embodiment of the present disclosure. FIG. 4 is a schematic view of a light path in the backlight module 200 of FIG. 3 after a light ray enters into the backlight module 200. As shown in FIG. 3, the backlight module 200 includes the light guiding plate 100, an optical auxiliary tool 220 and a light source 240. The optical auxiliary tool 200 has an opening 222 and a reflective surface 224. The reflective surface 224 covers the inside of the optical auxiliary tool 220. The reflective surface 224 is configured for reflecting a light ray 300 (please refer to FIG. 4) from the light source 240. At least part of the light guiding plate 100, such as the light incident surface 130, part of the light emitting surface 110, etc., can enter into the optical auxiliary tool 220 from the opening 222. In other words, an end of the light emitting surface 110 of the light guiding plate 100 near to the light incident surface 130 and at least part of the light incident surface 130, such as the first subsidiary light incident surface 132 adjacent to the light emitting surface 110, can cover in the optical auxiliary tool 220. In some embodiments, the scattering layer 150 can cover the part (not shown) of the light emitting surface 110 covering outside the optical auxiliary tool 220. The light source 240 is disposed in the optical auxiliary tool 220. As shown in FIG. 4, the light source 240 is configured for emitting the light ray 300. The light ray 300 can enter into the light guiding plate 100 through the reflection by the optical auxiliary tool 220 and leave from the light emitting surface 110.

Please refer to FIGS. 3-4. The light ray 300 can enter into the light guiding plate 100 along different light paths, such as light paths 320, 340, etc. For example, the light ray 300 enters into the light guiding plate 100 from the first subsidiary light incident surface 132 along the light path 320. In some embodiments, a second angle θ2 included between the first subsidiary light incident surface 132 of the light guide plate 100 and the light emitting surface 110 ranges from 40 degrees to 70 degrees. Apart from receiving more angle of the light ray 300 to enter into the light guiding plate 100, the light ray 300 is more readily to leave from the light emitting surface 110 after entering into the light guiding plate 100. For example, the light ray 300 leaves the light guiding plate 100 from the light emitting surface 110 along the light path 420. In addition, the light path 420 can pass through the micro-particles 154 distributed in the transparent main body 152. Furthermore, the light ray 300 is scattered by the micro-particles 154 to form a scattered light 520 with more angles.

In some other embodiments, the light incident surface 130 can further include a second subsidiary light incident surface 134. The second subsidiary light incident surface 134 is connected between the first subsidiary light incident surface 132 and the structural surface 120. The second angle 62 included between the first subsidiary light incident surface 132 and the light emitting surface 110 is larger than a third angle θ3 included between an extension surface of the second subsidiary light incident surface 134 and the light emitting surface 110 (or an extension surface of the light emitting surface 110). In some embodiments, the third angle θ3 ranges from 20 degrees to 40 degrees. In this way, when part of the light ray 300 enters into the light guiding plate 100 from the light emitting surface 110 along the light path 340, a total reflection will happen at the second subsidiary light incident surface 134 along the light path 440. The light ray 300 will be refracted to the light emitting surface 110 through the trench structures 140, and the light ray 300 will leave the light guiding plate 100. In addition, the light path 440 can pass through the micro-particles 154 distributed in the transparent main body 152. Furthermore, the light ray 300 is scattered by the micro-particles 154 to form a scattered light 530 with more angles. In some other embodiments, part of the light ray 300 is totally reflected at the light emitting surface 110, and refracted to the light emitting surface 110 through the trench structures 140 along the light path 460. However, this does not intend to limit the present disclosure. For example, the light ray 300 is totally reflected at the light emitting surface 110 and refracted at the trench structures 140 by at least once, and finally leaves from the light emitting surface 110.

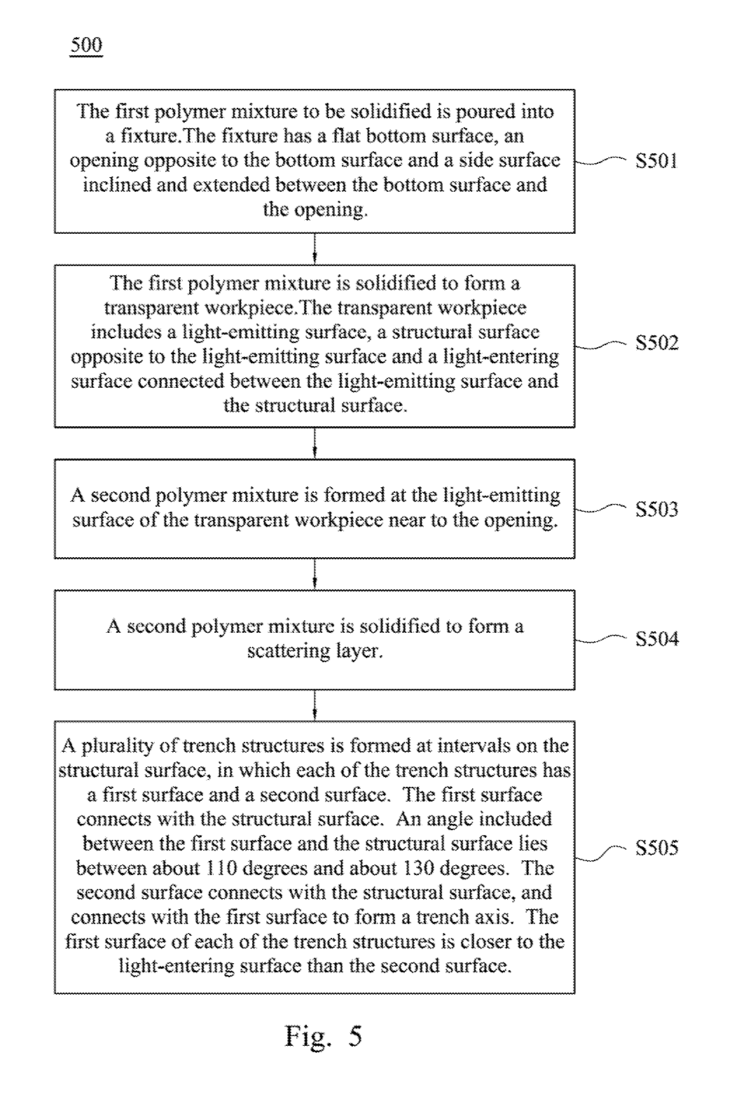

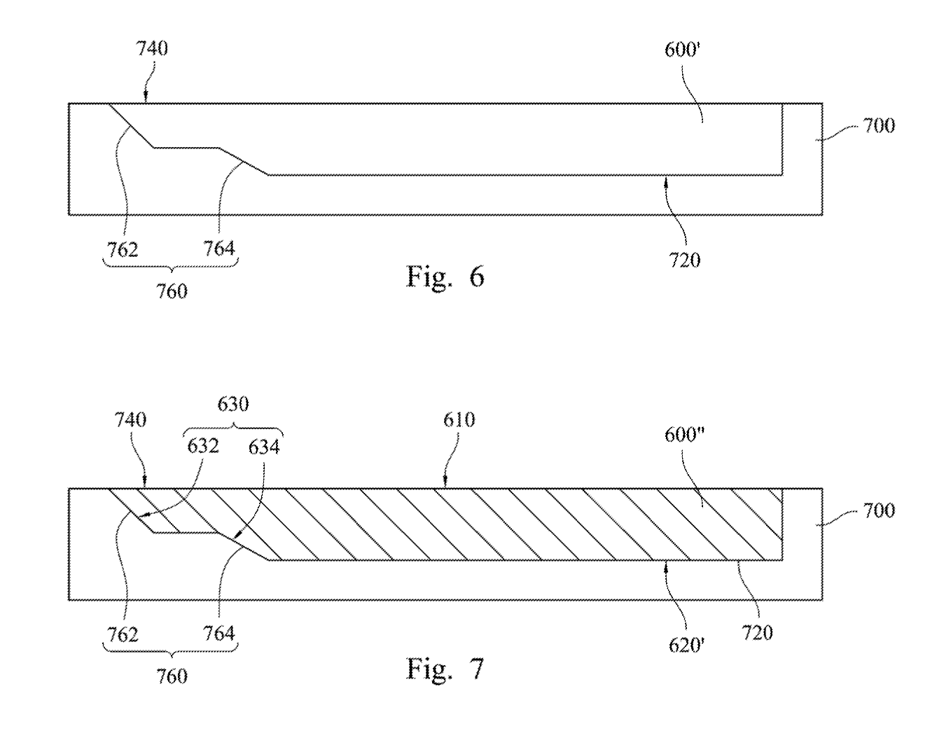

FIG. 5 is a flow chart of a manufacturing method 500 of a light guiding plate according to an embodiment of the present disclosure. FIGS. 6-9 are schematic sectional views of various stages in a manufacturing method of a light guiding plate 600 according to different embodiments of the present disclosure. As shown in FIG. 5, the manufacturing method 500 starts from step S501. In step S501, as shown in FIG. 6, the first polymer mixture 600′ to be solidified is poured into a fixture 700. In some embodiments, the fixture 700 has a flat bottom surface 720 and an opening 740 opposite to the bottom surface 720, so as to allow the first polymer mixture 600′ to form flat surfaces respectively at the bottom surface 720 and the opening 740. In some other embodiments, the fixture 700 further has a side surface 760 inclined and extended between the bottom surface 720 and the opening 740. In some embodiments, the side surface 760 includes a first subsidiary side surface 762 and a second subsidiary side surface 764. In some embodiments, an angle included between the first subsidiary side surface 762 and the bottom surface 720 is different from an angle included between the second subsidiary side surface 764 and the bottom surface 720. In some embodiments, the angle included between the first subsidiary side surface 762 and the bottom surface 720 is smaller than the angle included between the second subsidiary side surface 764 and the bottom surface 720. In some embodiments, the first polymer mixture 600′ is statically placed in an environment close to vacuum until the gas bubbles within the first polymer mixture 600′ are eliminated. Afterwards, the first polymer mixture 600′ is poured into the fixture 700. For example, the first polymer mixture 600′ can be statically placed in vacuum for about 30 minutes.

Consequently, it comes with the step S502 of the manufacturing method 500. In the step S502, as shown in FIG. 7, the first polymer mixture 600′ is solidified to form a transparent workpiece 600″. In some embodiments, the transparent workpiece 600″ includes a light emitting surface 610 and a structural surface 620′ opposite to the light emitting surface 610. The structural surface 620′ corresponds to the bottom surface 720. The light emitting surface 610 corresponds to the opening 740. In some other embodiments, the transparent workpiece 600″ further includes a light incident surface 630 connected between the light emitting surface 610 and the structural surface 620′. The light incident surface 630 corresponds with the side surface 760. In some other embodiments, the light incident surface 630 can further include a first subsidiary light incident surface 632 and a second subsidiary light incident surface 634, respectively corresponding with the first subsidiary side surface 762 and the second subsidiary side surface 764. In some embodiments, the transparent workpiece 600″ is formed through increasing the temperature for the solidification of the first polymer mixture 600′. For example, the first polymer mixture 600′ can be baked in an oven at a temperature of 75° C. for about 1 hour. However, this does not intend to limit the present disclosure.

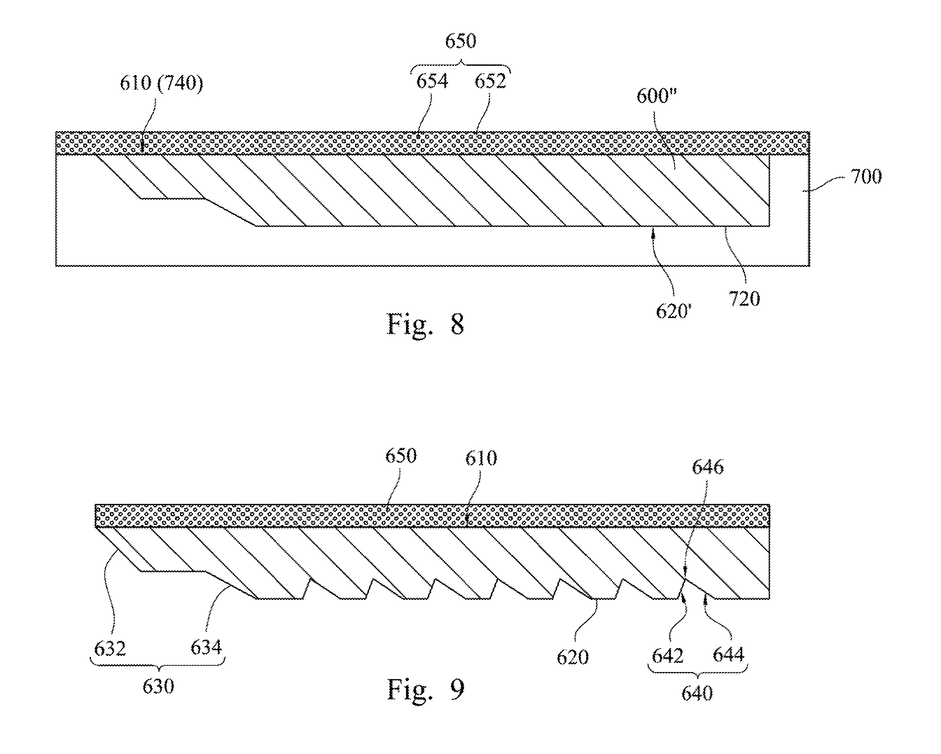

Consequently, it comes with the steps S503, S504 of the manufacturing method 500. In the steps S503, S504, as shown in FIG. 8, at the light emitting surface 610 of the transparent workpiece 600″ near to the opening 740, a second polymer mixture is formed and solidified, so as to form a scattering layer 650. The scattering layer 650 covers at least part of the light emitting surface 610. In some embodiments, the material of the second polymer mixture can be the same as or different from the material of the first polymer mixture 600′. In some embodiments, through the rotation of the transparent workpiece 600″ and the fixture 700, the second polymer mixture can be evenly coated on the light emitting surface 610. In some embodiments, the second polymer mixture can have micro-particles 654 floating within. After the second polymer mixture is solidified to form the scattering layer 650, the micro-particles 654 are distributed in the scattering layer 650, which can diverge the light ray with the light paths passing through the micro-particles 654. In some embodiments, the scattering layer 650 can be formed through increasing the temperature for the solidification of the second polymer mixture. For example, the second polymer mixture can be baked in an oven at a temperature of 75° C. for about 1 hour. However, this does not intend to limit the present disclosure.

Consequently, it comes with the step S505 of the manufacturing method 500. In the step S505, as shown in FIG. 9, the trench structures 640 are formed at intervals on the structural surface 620, in which the trench structures 640 correspond with the trench structures 140 in FIG. 1. In some embodiments, the trench structures 640 can be formed on the structural surface 620 through a method of laser engraving. However, this does not intend to limit the present disclosure. In some other embodiments, other appropriate etching methods can be applied to form the trench structures 640 on the structural surface 620.

In some embodiments, the materials and the corresponding refractive indexes as collated in Table 1 below can be referred for the material of the first polymer mixture 600′ and the second polymer mixture. The material of the first polymer mixture 600′ and the second polymer mixture can be of a single material or a complex of multiple materials.

TABLE 1
The materials and the corresponding refractive indexes
for the first and the second polymer mixture

| Material | Refractive Index (n) |
|---|---|
| Polydimethylsiloxane (PDMS) | 1.4-1.6 |
| Polycarbonate (PC) | 1.59 |
| Polymethylmethacrylate (PMMA) | 1.49 |
| Polyethylene terephthalate (PET) | 1.58 |
| Low density polyethylene (LDPE) | 1.51 |

This means, in some embodiments, the value of the refractive index n of the transparent workpiece 600″ (the light guiding plate 100) ranges from 1.4 to 1.6. In addition, in some embodiments, the transparent workpiece 600″ (the light guiding plate 100) can have flexibility.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A light guiding plate, comprising:
a light emitting surface;
a structural surface opposite to the light emitting surface;
a light incident surface connected between the light emitting surface and the structural surface; and
a plurality of trench structures formed at intervals on the structural surface, wherein each of the trench structures comprises:
a first surface connected with the structural surface, and a first angle included between the first surface and the structural surface ranges from 110 degrees to 130 degrees; and
a second surface connected with the structural surface, and the second surface connected with the first surface to form a trench axis;
wherein the first surface of each of the trench structures is closer to the light incident surface relative to the corresponding second surface.

2. The light guiding plate of claim 1, wherein a reflective index of the light guiding plate ranges from 1.4 to 1.6.

3. The light guiding plate of claim 1, wherein a distance between the trench axis of each of the trench structures and the adjacent trench axis ranges from 300 μm to 500 μm.

4. The light guiding plate of claim 3, wherein a distance between each of the trench axes and the adjacent trench axis is the same.

5. The light guiding plate of claim 1, wherein the trench axes of the trench structures are parallel with each other.

6. The light guiding plate of claim 1, wherein a distance between a first connection point where the first surface of each of the trench structures and the structural surface connect and a second connection point where the second surface and the structural surface connect ranges from 150 μm to 250 μm.

7. The light guiding plate of claim 1, wherein a perpendicular distance from the trench axis of each of the trench structures to a virtual extension surface of the structural surface ranges from 50 μm to 150 μm.

8. The light guiding plate of claim 7, wherein the perpendicular distance from each of the trench axes to the virtual extension surface is the same.

9. The light guiding plate of claim 7, wherein the respective perpendicular distances from at least two trench axes to the virtual extension surface are different from each other.

10. The light guiding plate of claim 1, wherein the first angle included between the first surface of each of the trench structures and the structural surface is the same.

11. The light guiding plate of claim 1, wherein the respective first angles included between the first surface of at least two trench structures and the structural surface are different from each other, wherein the first angle of either one of the two trench structures relatively closer to the light incident surface is smaller than or equal to the first angle of either one of the trench structures relatively farther away from the light incident surface.

12. The light guiding plate of claim 1, further comprising a scattering layer disposed on the light emitting surface.

13. The light guiding plate of claim 12, wherein the scattering layer comprises:
a transparent main body; and
a plurality of micro-particles distributed in the transparent main body.

14. The light guiding plate of claim 1, wherein a second angle included between the light incident surface and the light emitting surface ranges from 40 degrees to 70 degrees.

15. The light guiding plate of claim 1, wherein the light incident surface comprises:
a first subsidiary light incident surface connected to the light emitting surface; and
a second subsidiary light incident surface connected between the first subsidiary light incident surface and the structural surface;
wherein a second angle included between the first subsidiary light incident surface and the light emitting surface is larger than a third angle included between an extension surface of the second subsidiary light incident surface and an extension surface of the light emitting surface.

16. The light guiding plate of claim 15, wherein the third angle included between the second subsidiary light incident surface and the light emitting surface ranges from 20 degrees and to 40 degrees.

17. A backlight module, comprising:
the light guiding plate of claim 1;
an optical auxiliary tool covering at least part of the light incident surface of the light guiding plate and an end of the light emitting surface near to the light incident surface; and
a light source disposed in the optical auxiliary tool and configured for emitting a light ray;
wherein the optical auxiliary tool is configured for reflecting the light ray to the light guiding plate.

18. A method of manufacturing a light guiding plate, the method comprising:
providing a transparent workpiece, the transparent workpiece comprising a light emitting surface, a structural surface opposite to the light emitting surface, and a light incident surface connected between the light emitting surface and the structural surface; and
forming a plurality of trench structures at intervals on the structural surface, wherein each of the trench structures comprises a first surface and a second surface, the first surface connects with the structural surface, and a first angle included between the first surface and the structural surface ranges from 110 degrees to 130 degrees, the second surface connects with the structural surface, and the second surface connects with the first surface to form a trench axis, wherein the first surface of each of the trench structures is closer to the light incident surface relative to the corresponding second surface.

19. The method of claim 18, wherein the light incident surface comprises:
a first subsidiary light incident surface connected to the light emitting surface; and
a second subsidiary light incident surface connected between the first subsidiary light incident surface and the structural surface;
wherein a second angle included between the first subsidiary light incident surface and the light emitting surface is larger than a third angle included between an extension surface of the second subsidiary light incident surface and an extension surface of the light emitting surface.

20. The method of claim 18, further comprising:
forming a scattering layer on the transparent workpiece to cover at least part of the light emitting surface.
